(19) United States
(12) Patent Application Publication
(10) Pub. No.: US 2007/0220710 A1
(43) Pub. Date: Sep. 27, 2007

(54) Handle for hand tool

(76) Inventor: Chih-Ching Hsieh, Taichung City (TW)

Correspondence Address: PHILLIP LIU, 6980, WHITEOAK DR., RICHMOND, BC, V7EAZ9, CA

(21) Appl. No.: 11/389,191

(22) Filed: Mar. 27, 2006

(51) Int. Cl. E05B 1/00

(52) U.S. Cl. 16/436

(57) ABSTRACT

A hand tool includes a handle and a shank connected to an end of the handle. The handle has a first section and a second section which is located opposite to the shank. The first section has even numbers of recesses and the second section has odd numbers of grasping areas. The recesses are located alternatively to the grasping areas. The user's thumb is engaged with one of the recesses and the rest of the fingers of the user's hand hold one or two of the grasping areas to apply a large torque to the object to be tightened or loosened.

### FIELD OF THE INVENTION

The present invention relates to a handle of a hand tool wherein the handle includes even numbers of recesses and odd numbers of grasping areas for the thumb and the rest of fingers to hold the handle firmly.

### BACKGROUND OF THE INVENTION

A conventional hand tool generally includes a handle and a shank with a specific function. The handle usually is made to have curved surfaces so that the user can easily hold the handle. The diameter of the handle is larger than the diameter of the shank so that when the user holds the handle and rotates the handle, the shank applies an output torque to the object to be loosened or tightened. Nevertheless, the conventional handle is shaped so that the thumb and the rest of the fingers do not have a proper place to press so that the user cannot apply sufficient torque to the handle. Some handles have bosses projecting from the surface of the handle to increase friction between the user's hand and the handle. However, the user's hand does not feel comfortable when the bosses are in contact with the hand. Some handles have a rectangular cross section which is helpful for the user to hold the handle firmly. However, the handle lacks proper positions for the user's thumb and fingers.

The present invention intends to provide a handle for a hand tool wherein there are even numbers of recesses for the user's thumb and odd numbers of grasping areas for the rest of the fingers. The user's fingers firmly engage with the recesses to easily apply a large torque to the handle.

### SUMMARY OF THE INVENTION

The present invention relates to a hand tool that comprises a handle and a shank connected to an end of the handle. The handle includes a first section close to the end with the shank connected thereto, and a second section which is located opposite to the shank. The first section has even numbers of recesses so that the user's thumb is engaged with one of the recesses, and the second section has odd numbers of grasping areas so that the rest of the fingers of the user's can hold the handle firmly.

The primary object of the present invention is to provide a handle of a hand tool wherein the thumb and the rest of the fingers have proper positions to be engaged on the handle so that the user can hold the handle more firmly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the handle of the present invention;

FIG. 2 is a side view of the handle of the present invention;

FIG. 3 is another side view of the handle of the present invention;

FIG. 4 is a top view of the handle in FIG. 2;

FIG. 5 is a top view of the handle in FIG. 3, and

FIG. 6 is a cross sectional view along line A-A in FIG. 2;

FIG. 7 is a cross sectional view along line B-B in FIG. 2;

FIG. 8 shows that a user's hand holds the handle of the present invention.

### DETAILED DESCRIPTION OF THE PREFERRED EMBODIMENT

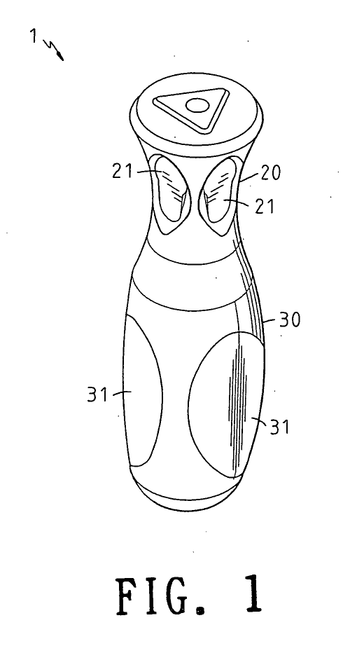

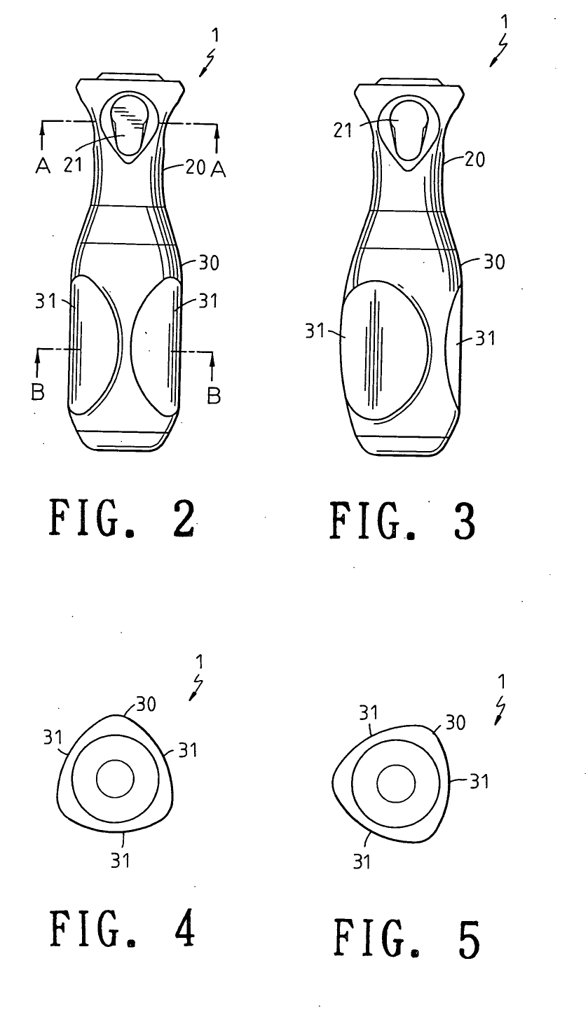

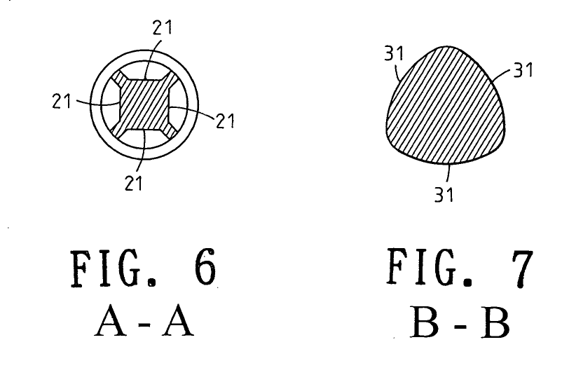

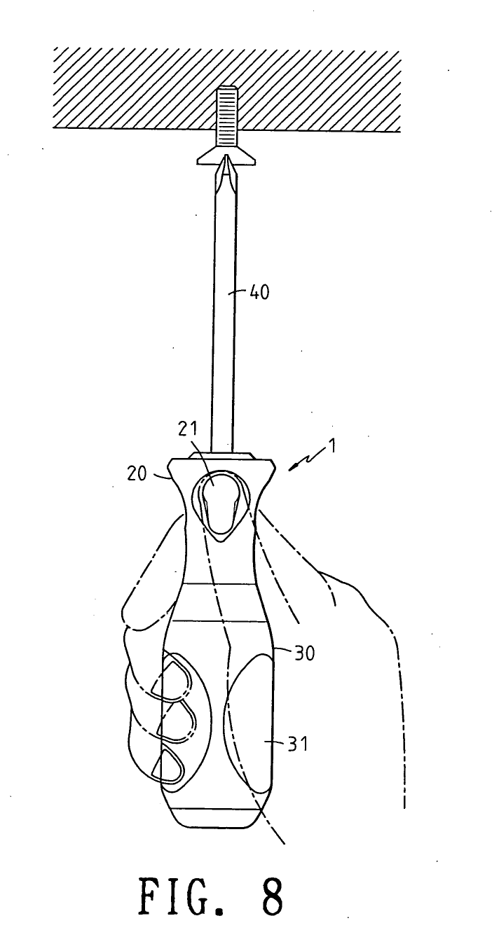

Referring to FIGS. 1 to 8, the hand tool of the present invention comprises a handle 1 and a shank 40 connected to an end of the handle 1, the shank 40 has a function end for being engaged with a screw head such as shown in FIG. 8. The handle 1 includes a first section 20 close to the end with the shank 40 connected thereto, and a second section 30 which is located opposite to the shank 40. The first section 20 has even numbers of recesses 21 and the second section 30 has odd numbers of grasping areas 31. The recesses 21 are located alternatively to the grasping areas 31. In this embodiment, there are four recesses 21 and three grasping areas 31. The user's thumb is engaged with one of the recesses 21 and the rest of the fingers of the hand can hold one or two of the grasping areas 31, thereby holding the handle 1 firmly. When rotating the screw, the thumb and the rest of the fingers are well positioned in the recesses 21 and grasping areas 31 so that the user can easily apply a large torque to the screw.

The first section 20 can have odd numbers of recesses 21 and the second section 30 has even numbers of grasping areas 31.

While we have shown and described the embodiment in accordance with the present invention, it should be clear to those skilled in the art that further embodiments may be made without departing from the scope of the present invention.

What is claimed is:

1. A hand tool comprising:
a handle and a shank connected to an end of the handle, the handle having a first section close to the end with the shank connected thereto, and a second section which is located opposite to the shank, the first section having even numbers of recesses and the second section having odd numbers of grasping areas.

2. The hand tool as claimed in claim 1, wherein the recesses are located alternatively to the grasping areas.

3. A hand tool comprising:
a handle and a shank connected to an end of the handle, the handle having a first section close to the end with the shank connected thereto, and a second section which is located opposite to the shank, the first section having odd numbers of recesses and the second section having even numbers of grasping areas.

4. The hand tool as claimed in claim 1, wherein the recesses are located alternatively to the grasping areas.
